(19) United States
(12) Patent Application Publication
(10) Pub. No.: US 2024/0158630 A1
(43) Pub. Date: May 16, 2024

(54) Thermoplastic Composition for Wire or Cable Jacket

(71) Applicant: DuPont Polymers, Inc., Wilmington, DE (US)

(72) Inventor: Steven R. Oriani, Landenberg, PA (US)

(21) Appl. No.: 18/497,252

(22) Filed: Oct. 30, 2023

Related U.S. Application Data
(60) Provisional application No. 63/420,860, filed on Oct. 31, 2022.

(51) Int. Cl. C08L 67/02; C08F 220/14; C08F 220/18; C08G 63/183; C08G 65/20; C08G 65/26; C08G 77/20; C08K 3/22; C08L 23/08

(52) U.S. Cl. CPC C08L 67/025; C08F 220/14; C08F 220/1804; C08G 63/183; C08G 65/20; C08G 65/2615; C08G 77/20; C08K 3/22; C08L 23/0869; C08K 2003/2227; C08K 2201/019; C08L 2203/202; C08L 2205/03; C08L 2207/04

(57) ABSTRACT

The present disclosure is directed to a thermoplastic composition. The thermoplastic composition comprises: a) a copolyether-ester; b) an ethylene acrylic copolymer as defined; and c) aluminum trihydrate (ATH), present in an amount of at least 40% by weight of the thermoplastic composition; wherein the weight ratio of the copolyether-ester to the ethylene acrylic copolymer in the thermoplastic composition ranges from 98:2 to 65:35. The present disclosure is also directed to a wire or cable jacket formed from the thermoplastic composition.

### CROSS-REFERENCE TO RELATED APPLICATION

This application claims priority to and the benefit of U.S. Provisional Patent Application No. 63/420,903 filed on Oct. 31, 2022, which is incorporated by reference in its entirety.

### BACKGROUND

Due to excellent mechanical properties (e.g., tear strength, tensile strength, flex life, and abrasion resistance), polymeric compositions based on copolyether-ester elastomers have been used in forming components for many applications, such as for jackets for cables and wires. For such applications, various additives may be utilized to obtain the desired properties, such as desired mechanical properties, flame retardance, and/or thermal stability. In addition, such compositions may also include various additives that are used to assist in processability. However, oftentimes, such combination of additives may not provide the desired combination of mechanical properties, processability, and flame retardance and/or thermal stability. Thus, while maintaining mechanical properties, it is desirable that such copolyether-ester-based compositions have good processability as well as low flammability and/or high thermal stability. Further, as operating temperatures and performance requirements increase, there is a growing need for copolyether-ester compositions having improved retention of mechanical properties on prolonged heat exposure.

### SUMMARY

In accordance with one embodiment of the present disclosure, a thermoplastic composition is disclosed. The thermoplastic composition comprises: a) a copolyether-ester; b) an ethylene acrylic copolymer comprising: (i) copolymerized units of a monomer having the structure:

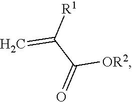

wherein R¹ is hydrogen or C₁-C₁₂ alkyl, and R² is C₁-C₁₂ alkyl, C₁-C₂₀ alkoxyalkyl, C₁-C₁₂ cyanoalkyl, or C₁-C₁₂ haloalkyl, and wherein the polymerized units of the monomer are present in an amount ranging from about 40% to about 70% by weight of the ethylene acrylic copolymer; (ii) copolymerized units of an unsaturated carboxylic acid or an anhydride thereof, present in an amount of at least 2% by weight of the ethylene acrylic copolymer; and (iii) copolymerized units of ethylene; and c) aluminum trihydrate (ATH), present in an amount of at least 40% by weight of the thermoplastic composition; wherein the weight ratio of the copolyether-ester to the ethylene acrylic copolymer in the thermoplastic composition ranges from 98:2 to 65:35. The present disclosure is also directed to a wire or cable jacket formed from the thermoplastic composition.

In accordance with another embodiment of the present disclosure, a wire or cable jacket formed from the aforementioned thermoplastic composition is disclosed.

In accordance with another embodiment of the present disclosure, a wire or cable comprising a jacket formed from the aforementioned thermoplastic composition is disclosed.

### DETAILED DESCRIPTION

It is to be understood by one of ordinary skill in the art that the present discussion is a description of exemplary embodiments only and is not intended as limiting the broader aspects of the present disclosure.

Generally speaking, the present disclosure is directed to a thermoplastic composition including a copolyether-ester, an ethylene acrylic copolymer as defined herein, and aluminum trihydrate (ATH) in an amount of at least 40% by weight of the thermoplastic composition. In addition, the weight ratio of the copolyether-ester to the ethylene acrylic copolymer in the thermoplastic composition ranges from 98:2 to 65:35. The present inventor has discovered that such a composition can exhibit the desired mechanical properties as well as other desired properties allowing the composition to be processed using standard techniques. For instance, the thermoplastic composition may exhibit a suitable melt flow index for good extrusion processability, and a number of other excellent properties, including tensile strength, elongation, and limiting oxygen index, which can provide improved flame retardance and low smoke generation.

In some examples, the thermoplastic composition exhibits a melt flow index of at least 1 g/10 min, e.g., ranging from about 1 g/10 min to about 3 g/10 min, measured according to ASTM D1238-20 (procedure A), conducted at 170° C. using a 21 kg weight. For example, the melt flow index may be about 1 g/10 min or more, such as about 1.2 g/10 min or more, such as about 1.4 g/10 min or more, such as about 1.6 g/10 min or more, such as about 1.8 g/10 min or more, such as about 2 g/10 min or more, such as about 2.2 g/10 min or more, such as about 2.4 g/10 min or more. The melt flow index may be about 3 g/10 min or less, such as about 2.8 g/10 min or less, such as about 2.6 g/10 min or less, such as about 2.4 g/10 min or less, such as about 2.2 g/10 min or less, such as about 2 g/10 min or less, such as about 1.8 g/10 min or less, such as about 1.6 g/10 min or less, such as about 1.4 g/10 min or less.

In a further example, the thermoplastic composition exhibits a tensile strength ranging from about 8 MPa to about 16 MPa, measured according to ASTM D420-6, die C, from a sample stamped from the machine direction of extruded tapes having a thickness of about 0.8 mm. For example, the tensile strength may be about 8 MPa or more, such as about 9 MPa or more, such as about 10 MPa or more, such as about 11 MPa or more, such as about 12 MPa or more, such as about 13 MPa or more, such as about 14 MPa or more. The tensile strength may be about 16 MPa or less, such as about 15 MPa or less, such as about 14 MPa or less, such as about 13 MPa or less, such as about 12 MPa or less, such as about 11 MPa or less, such as about 10 MPa or less, such as about 9 MPa or less.

The thermoplastic composition can in some examples exhibit an elongation at break, measured according to ASTM D420-6, die C, ranging from about 60% to about 230%. In a further example, the thermoplastic composition exhibits an elongation at break ranging from about 180% to about 230%. For example, the elongation at break may be about 60% or more, such as about 80% or more, such as about 100% or more, such as about 120% or more, such as about 140% or more, such as about 160% or more, such as about 180% or more, such as about 200% or more. The elongation at break may be about 230% or less, such as about 210% or less, such as about 200% or less, such as about 180% or less, such as about 160% or less, such as about 140% or less, such as about 120% or less, such as about 100% or less, such as about 80% or less.

In some examples, the thermoplastic exhibits a limiting oxygen index ranging from about 35% to about 60% (e.g., 42% to 60%, or 42% to 55%), measured according to ASTM D2863-19, procedure A, using a type I specimen cut from a compression molded plaque. For example, the limiting oxygen index may be about 35% or more, such as about 38% or more, such as about 40% or more, such as about 42% or more, such as about 45% or more, such as about 48% or more, such as about 50% or more. The limiting oxygen index may be about 60% or less, such as about 58% or less, such as about 55% or less, such as about 52% or less, such as about 50% or less, such as about 48% or less, such as about 45% or less, such as about 43% or less, such as about 40% or less.

Copolyether-ester

Suitable copolyether-esters have a multiplicity of recurring long-chain ester units and short-chain ester units joined head-to-tail through ester linkages, the long-chain ester units being represented by formula (A):

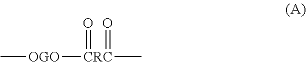

and said short-chain ester units being represented by formula (B):

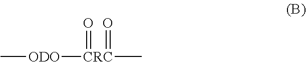

wherein
G is a divalent radical remaining after the removal of terminal hydroxyl groups from poly(alkylene oxide)glycols having a number average molecular weight of between about 400 and about 6000 Da, preferably between about 400 and about 3000 Da, even more preferably between about 600 and about 3000 Da;
R is a divalent radical remaining after removal of carboxyl groups from a dicarboxylic acid having a molecular weight of less than about 300 Da;
D is a divalent radical remaining after removal of hydroxyl groups from a diol having a molecular weight less than about 250 Da.

The term “about” as used here and elsewhere in this application refers to the stated numerical unit ±10%.

The term “long-chain ester units” as applied to units in a polymer chain refers to the reaction product of a long-chain glycol with a dicarboxylic acid. Suitable long-chain glycols are poly(alkylene oxide) glycols having terminal (or as nearly terminal as possible) hydroxy groups and having a number average molecular weight of from about 400 to about 6000 Da, preferably from about 600 to about 3000 Da, even more preferably between about 600 and about 3000 Da, even more preferably between about 1000 to about 3000 Da, even more preferably between 1000 to about 2000 Da. In addition, the long-chain glycols may have a melting point of less than about 65° C., such as less than about 60° C., such as less than about 55° C., such as less than about 50° C. The long chain glycols are generally poly(alkylene oxide) glycols or glycol esters of poly(alkylene oxide) dicarboxylic acids. Preferred poly(alkylene oxide) glycols include poly(tetramethylene oxide) glycol, poly(trimethylene oxide) glycol, poly(propylene oxide) glycol, poly(ethylene oxide) glycol, poly(hexamethylene oxide) glycol, poly(heptamethylene oxide) glycol, poly(octamethylene oxide) glycol, poly(nonamethylene oxide) glycol, and poly(1,2-butylene oxide) glycol, copolymer glycols of these alkylene oxides, and block copolymers such as ethylene oxide-capped poly(propylene oxide) glycol. Mixtures of two or more of these glycols can be used. Long chain ester units of Formula (A) may also be referred to as “soft segments” of a copolyether-ester polymer.

The term “short-chain ester units” as applied to units in a polymer chain of the copolyether-esters refers to low molecular weight compounds or polymer chain units having molecular weights less than about 550 Da, such as less than about 525 Da, such as less than about 500 Da, such as less than about 475 Da, such as less than about 450 Da. They are made by reacting a low molecular weight diol or a mixture of diols (molecular weight below about 250 Da, such as below about 225 Da, such as below about 200 Da, such as below about 175 Da, such as below about 150 Da) with a dicarboxylic acid to form ester units represented by Formula (B) above. Short chain ester units of Formula (B) may also be referred to as “hard segments” of the copolyether-ester polymer.

Included among the low molecular weight diols which react to form short-chain ester units for preparing copolyesters are acyclic, alicyclic and aromatic dihydroxy compounds. Low molecular weight diols which react to form short-chain ester units include aliphatic diols containing 2 to 8 carbon atoms, such as about 2 to about 6 carbon atoms, such as ethylene, propylene, isobutylene, tetramethylene, 1,4-pentamethylene, 2,2-dimethyltrimethylene, hexamethylene and decamethylene glycols, dihydroxycyclohexane, cyclohexane dimethanol, resorcinol, hydroquinone, 1,5-dihydroxynaphthalene, and the like. In particular, the diol may be an aliphatic diol, such as 1,4-butanediol, ethylene glycol, 1,3-propanediol, cyclohexanedimethanol, and/or hexamethylene glycol. For instance, the diol may be ethylene glycol, 1,4 butanediol, 1,3-propane diol, or a combination thereof. In particular, the diol may be 1,4 butanediol, 1,3-propane diol, or a combination thereof. In one embodiment, 1,4-butanediol is preferred. In another embodiment, ethylene glycol is preferred. In another further embodiment, 1,3-propanediol is preferred. In one embodiment, 1,4-butanediol may be provided as a mixture with ethylene glycol, 1,3-propanediol, cyclohexanedimethanol, and/or hexamethylene glycol. Included among the bisphenols which can be used are bis(p-hydroxy)diphenyl, bis(p-hydroxyphenyl)methane, and bis(p-hydroxyphenyl)propane. Equivalent ester-forming derivatives of diols are also useful (e.g., ethylene oxide or ethylene carbonate can be used in place of ethylene glycol or resorcinol diacetate can be used in place of resorcinol). The term “diols” includes equivalent ester-forming derivatives such as those mentioned. For example, ethylene oxide or ethylene carbonate can be used in place of ethylene glycol. The molecular weights refer to the diols, not to the ester-forming derivatives.

Dicarboxylic acids that can react with long-chain glycols and low molecular weight diols to produce the copolyether-esters are aliphatic, cycloaliphatic or aromatic dicarboxylic acids of a low molecular weight (e.g., having a molecular weight of less than about 300 Da, such as less than about 275 Da, such as less than about 250 Da, such as less than about 225 Da). The term “dicarboxylic acids” includes functional equivalents of dicarboxylic acids that have two carboxyl functional groups that perform substantially similarly to dicarboxylic acids in reaction with glycols and diols in forming copolyether-ester polymers. These equivalents include esters and ester-forming derivatives such as acid halides and anhydrides. The molecular weight in this context pertains to the acid and not to its equivalent ester or ester-forming derivative. Thus, an ester of a dicarboxylic acid having a molecular weight greater than 300 or a functional equivalent of a dicarboxylic acid having a molecular weight greater than 300 are also suitable, provided the corresponding acid has a molecular weight below about 300 or the aforementioned molecular weights.

Aliphatic dicarboxylic acids refer to carboxylic acids having two carboxyl groups, each attached to a saturated carbon atom. If the carbon atom to which the carboxyl group is attached is saturated and is in a ring, the acid is cycloaliphatic. Aliphatic or cycloaliphatic acids having conjugated unsaturation often may not be used because of homopolymerization. However, some unsaturated acids, such as maleic acid, may be used.

Aromatic dicarboxylic acids can be used. The term “aromatic dicarboxylic acids” refers to dicarboxylic acids having two carboxyl groups each attached to a carbon atom in a carbocyclic aromatic ring structure. It is not necessary that both functional carboxyl groups be attached to the same aromatic ring and where more than one ring is present, they can be joined by aliphatic or aromatic divalent radicals or divalent radicals such as −O— or —SO₂—.

Suitable aliphatic and cycloaliphatic acids that can be used include, but are not limited to, sebacic acid; 1,3-cyclohexane dicarboxylic acid; 1,4-cyclohexane dicarboxylic acid; adipic acid; glutaric acid; succinic acid; 4-cyclohexane-1,2-dicarboxylic acid; 2-ethylsuberic acid; cyclopentanedicarboxylic acid, decahydro-1,5-naphthylene dicarboxylic acid; 4,4′-bicyclohexyl dicarboxylic acid; decahydro-2,6-naphthylene dicarboxylic acid; 4,4′-methylenebis (cyclohexyl) carboxylic acid; 3,4-furan dicarboxylic acid; and mixtures thereof. In one embodiment, the preferred acid may include a cyclohexane dicarboxylic acid and/or adipic acid.

Suitable aromatic dicarboxylic acids include phthalic, terephthalic and isophthalic acids; dibenzoic acid; substituted dicarboxy compounds with two benzene nuclei such as bis(p-carboxyphenyl)methane; p-oxy-1,5-naphthalene dicarboxylic acid; 2,6-naphthalene dicarboxylic acid; 2,7-naphthalene dicarboxylic acid; 4,4′-sulfonyl dibenzoic acid and C₁-C₁₂ alkyl and ring substitution derivatives thereof, such as halo, alkoxy, and aryl derivatives. Hydroxy acids such as p-(beta-hydroxyethoxy)benzoic acid can also be used provided an aromatic dicarboxylic acid is also used. Aromatic acids with 8 to 16 carbon atoms are suitable, including terephthalic acid, isophthalic acid, and mixtures of phthalic acid and isophthalic acid.

In one embodiment, an aromatic dicarboxylic acid is preferred for preparing the copolyether-ester. Among the aromatic dicarboxylic acids, those with 8 to 16 carbon atoms, such as 8 to 12 carbon atoms, such as 8 to 10 caron atoms may be preferred. In particular, the aromatic dicarboxylic acid may include terephthalic acid, phthalic acid, and/or isophthalic acid. In particular, the aromatic dicarboxylic acid may include terephthalic acid, isophthalic acid, or a combination thereof. In one embodiment, the aromatic acid may include terephthalic acid alone or with a mixture of phthalic acid and/or isophthalic acid.

When a mixture of two or more dicarboxylic acids is used to prepare the copolyether-ester, isophthalic acid may be a preferred second dicarboxylic acid in one embodiment. For instance, isophthalic acid may be provided in a mixture with terephthalic acid. In this regard, the amount of copolymerized isophthalate residues in the copolyether-ester may be less than 35 mole %, such as less than 30 mole %, such as less than 25 mole %. Similarly, copolymerized isophthalate residues in the copolyether-ester may be less than 35 wt. %, such as less than 30 wt. %, such as less than 25 wt. %, based on the total weight of copolymerized dicarboxylic acid residues —(—C(O)RC(O)—)— in the copolyether-ester. The remainder of the phenylene diradicals may be derived from terephthalic acid based on the total number of moles of copolymerized dicarboxylic acid residues —(—C(O)RC(O)—)— in the copolyether-ester.

In addition, in one embodiment, at least about 70 mol. % of the groups represented by R in Formulae (A) and (B) above may be 1,4-phenylene radicals and at least about 70 mol. % of the groups represented by D in Formula (B) above may be 1,4-butylene radicals and the sum of the percentages of R groups which are not 1,4-phenylene radicals and D groups which are not 1,4-butylene radicals may not exceed 30 mol. %.

For example, the copolyether-ester may have hard segments composed of polybutylene terephthalate and about 5 wt. % to about 80 wt. %, such as about 5 wt. % to about 75 wt. %, such as about 10 wt. % to about 70 wt. %, such as about 10 wt. % to about 60 wt. %, such as about 20 wt. % to about 60 wt. %, of soft segments composed of the reaction product of a polyether glycol and an aromatic diacid. The polyether blocks may be derived from polytetramethylene glycol. Complementarily, the fraction of hard segments may be about 20 wt. % to about 95 wt. %, such as about 20 wt. % to about 90 wt. %, such as about 30 wt. % to about 90 wt. %, such as about 40 wt. % to about 90 wt. %, such as about 40 wt. % to about 80 wt. %.

While not limited, preferred copolyether-esters may include those prepared from monomers comprising the following: (A) (1) poly(tetramethylene oxide) glycol, (2) a dicarboxylic acid selected from isophthalic acid, terephthalic acid or a mixture thereof, and (3) a diol selected from 1,4-butanediol, 1,3-propanediol or a mixture thereof; (B) (1) poly(trimethylene oxide) glycol, (2) a dicarboxylic acid selected from isophthalic acid, terephthalic acid or a mixture thereof, and (3) a diol selected from 1,4-butanediol, 1,3-propanediol or a mixture thereof; or (C) (1) ethylene oxide-capped poly(propylene oxide) glycol; (2) a dicarboxylic acid selected from isophthalic acid, terephthalic acid or a mixture thereof; and (3) a diol selected from 1,4-butanediol, 1,3-propanediol or a mixture thereof.

Preferably, the copolyether-esters may be prepared from esters or mixtures of esters of terephthalic acid or isophthalic acid, 1,4-butanediol and poly(tetramethylene ether)glycol, poly(trimethylene ether) glycol, or ethylene oxide-capped polypropylene oxide glycol or may be prepared from esters of terephthalic acid (e.g., dimethylterephthalate), 1,4-butanediol and poly(ethylene oxide)glycol). More preferably, the copolyether-esters may be prepared from esters of terephthalic acid (e.g., dimethylterephthalate), 1,4-butanediol and poly(tetramethylene ether)glycol.

For instance, in one particular embodiment, the copolyether-ester may have the following formula: -[4GT]x-[BT]y-, wherein 4G is the residue of butylene glycol, such as 1,4-butane diol, B is the residue of poly(tetramethylene ether glycol) and T is terephthalate, and wherein x is from about 0.60 to about 0.99 and y is from about 0.01 to about 0.40.

In one aspect, the copolyether-ester can be a block copolymer of polybutylene terephthalate and polyether segments and can have a structure as follows:

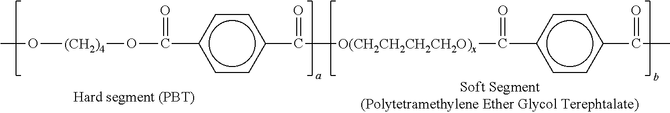

wherein a and b are integers and can vary from 2 to 10,000. The ratio between hard segments and soft segments in the block copolymer as described above can be varied in order to vary the properties of the elastomer.

In general, the copolyether-ester preferably comprises about 1 wt. % or more, such as about 5 wt. % or more, such as about 10 wt. % or more, such as about 20 wt. % or more, such as about 25 wt. % or more, such as about 30 wt. % or more, such as about 35 wt. % or more, such as about 40 wt. % or more, such as about 45 wt. % or more, such as about 50 wt. % or more, such as about 55 wt. % or more of copolymerized residues of long-chain ester units corresponding to Formula (A) above (hard segments). The copolyether-ester preferably comprises about 85 wt. % or less, such as about 80 wt. % or less, such as about 75 wt. % or less, such as about 70 wt. % or less, such as about 65 wt. % or less, such as about 60 wt. % or less of copolymerized residues of long-chain ester units corresponding to Formula (A) above (hard segments).

In general, the copolyether-ester preferably comprises about 15 wt. % or more, such as about 20 wt. % or more, such as about 25 wt. % or more, such as about 30 wt. % or more, such as about 35 wt. % or more, such as about 40 wt. % or more, such as about 45 wt. % or more, such as about 50 wt. % or more of copolymerized residues of short-chain ester units corresponding to Formula (B) above (soft segments). The copolyether-ester preferably comprises about 99 wt. % or less, such as about 95 wt. % or less, such as about 90 wt. % or less, such as about 85 wt. % or less, such as about 80 wt. % or less, such as about 75 wt. % or less, such as about 70 wt. % or less, such as about 65 wt. % or less, such as about 60 wt. % or less, such as about 55 wt. % or less of copolymerized residues of short-chain ester units corresponding to Formula (B) above (soft segments).

In one embodiment, the copolyether-ester may comprise only copolymerized residues of long-chain ester units corresponding to Formula (A) above and short-chain ester units corresponding to Formula (B) above. In this regard, the weight percentages of the copolymerized units of Formula (A) and Formula (B) in the copolyether-ester may be complementary. That is, the sum of the weight percentages of the copolymerized units of Formula (A) and Formula (B) may be 100 wt. %. Similarly, the mole percentages of the R groups in the copolymerized units of Formula (A) and Formula (B) in the copolyether-ester may be complementary. That is, the sum of the mole percentages of the R groups in the copolymerized units of Formula (A) and Formula (B) may be 100 mol %.

Furthermore, it should be understood that a mixture of two or more copolyether-esters can be used. In one embodiment, the composition may contain one copolyether-ester as defined herein. In other embodiments, the composition may include a mixture of copolyether-esters. For instance, more than one copolyether-ester, such as two or three copolyether-esters, may be utilized in the composition.

Specifically, regarding the copolyether-esters, in particular a mixture of copolyether-esters, each copolyether-esters used need not on an individual basis come within the values set forth above. In this regard, the mixture of two or more copolyether-esters may conform to the values described herein for the copolyether-esters on a weighted average basis, however. For example, in a mixture that contains equal amounts of two copolyether-esters, one copolyether-ester can contain 60 weight percent short-chain ester units and the other copolyether-ester can contain 30 weight percent short-chain ester units for a weighted average of 45 weight percent short-chain ester units.

Regarding the properties of the copolyether-ester, it may be desired to have a melt flow that can allow it to be processed in a relatively easy manner for the formation of a composition and resulting part/article as disclosed herein. In this regard, the copolyether-ester may exhibit a relatively low melt viscosity as indicated by the melt flow rate. For instance, the melt flow rate of the copolyether-ester may be about 0.5 g/10 min or more, such as about 1 g/10 min or more, such as about 2 g/10 min or more, such as about 3 g/10 min or more, such as about 4 g/10 min or more, such as about 5 g/10 min or more. The melt flow rate may be about 10 g/10 min or less, such as about 8 g/10 min or less, such as about 6 g/10 min or less, such as about 5 g/10 min or less, such as about 4 g/10 min or less, such as about 3 g/10 min or less. The melt flow rate may be determined at 220° C. under a 2.16 kg load according to IS01133.

The copolyether-ester may also have a relatively low melting temperature. For instance, the melting temperature may be about 100° C. or more, such as about 110° C. or more, such as about 130° C. or more, such as about 150° C. or more, such as about 170° C. or more, such as about 190° C. or more, such as about 200° C. or more, such as about 220° C. or more, such as about 240° C. or more. The melting temperature may be about 300° C. or less, such as about 280° C. or less, such as about 250° C. or less, such as about 230° C. or less, such as about 210° C. or less, such as about 200° C. or less, such as about 180° C. or less, such as about 160° C. or less, such as about 140° C. or less, such as about 120° C. or less. The melting temperature may be determined using means known in the art, such as differential scanning calorimetry in accordance with ISO 11357-1:2023 at a rate of 10° C./min. A low peak melting temperature may facilitate melt processing the composition while minimizing decomposition of aluminum trihydrate.

In addition, the glass transition temperature of the copolyether-ester may be within a particular range. For instance, the glass transition temperature may be about −80° C. or more, such as about −70° C. or more, such as about −60° C. or more, such as about −50° C. or more, such as about −40° C. or more, such as about −30° C. or more. The glass transition temperature may be about 0° C. or less, such as about −5° C. or less, such as about −10° C. or less, such as about −20° C. or less, such as about −30° C. or less, such as about −40° C. or less. Also, the glass transition temperature of the hard segment of the copolyether-ester may be within a particular range. For instance, the glass transition temperature of the hard segment may be about 30° C. or more, such as about 35° C. or more, such as about 40° C. or more, such as about 45° C. or more, such as about 50° C. or more, such as about 55° C. or more, such as about 60° C. or more, such as about 65° C. or more, such as about 70° C. or more, such as about 75° C. or more, such as about 80° C. or more. The glass transition temperature may be about 150° C. or less, such as about 140° C. or less, such as about 130° C. or less, such as about 120° C. or less, such as about 110° C. or less, such as about 100° C. or less, such as about 90° C. or less, such as about 80° C. or less, such as about 70° C. or less, such as about 60° C. or less, such as about 55° C. or less, such as about 50° C. or less, such as about 45° C. or less, such as about 40° C. or less, such as about 35° C. or less, such as about 30° C. or less. The glass transition temperature may be determined using means known in the art, such as differential scanning calorimetry in accordance with ISO 11357-1:2023 at a rate of 10° C./min.

Further, the copolyether-ester may have a particular density. For instance, the density be about 1 g/cm 3 or more, such as about 1.03 g/cm 3 or more, such as about 1.05 g/cm 3 or more, such as about 1.08 g/cm 3 or more, such as about 1.1 g/cm 3 or more, such as about 1.15 g/cm 3 or more, such as about 1.2 g/cm 3 or more, such as about 1.3 g/cm 3 or more. The copolyether-ester may have a density of about 2 g/cm 3 or less, such as about 1.8 g/cm 3 or less, such as about 1.6 g/cm 3 or less, such as about 1.4 g/cm 3 or less, such as about 1.3 g/cm 3 or less, such as about 1.25 g/cm 3 or less, such as about 1.2 g/cm 3 or less, such as about 1.18 g/cm 3 or less, such as about 1.15 g/cm 3 or less, such as about 1.12 g/cm 3 or less, such as about 1.1 g/cm 3 or less. The density may be determined in accordance with ISO 1183-1:2019.

In addition, the copolyether-ester utilized may exhibit a certain mechanical strength. In particular, the copolyether-ester may not be as likely to resist deformation in bending compared to other types of materials and as a result, the copolyether-ester may exhibit a relatively low flexural modulus. For instance, the flexural modulus may be about 300 MPa or less, such as about 260 MPa or less, such as about 220 MPa or less, such as about 200 MPa or less, such as about 190 MPa or less, such as about 180 MPa or less, such as about 170 MPa or less, such as about 160 MPa or less, such as about 150 MPa or less, such as about 140 MPa or less, such as about 130 MPa or less, such as about 120 MPa or less, such as about 110 MPa or less, such as about 100 MPa or less, such as about 90 MPa or less, such as about 80 MPa or less, such as about 70 MPa or less, such as about 60 MPa or less, such as about 50 MPa or less, such as about 40 MPa or less, such as about 30 MPa or less, such as about 20 MPa or less. The flexural modulus may be about 10 MPa or more, such as about 15 MPa or more, such as about 20 MPa or more, such as about 25 MPa or more, such as about 30 MPa or more, such as about 35 MPa or more, such as about 40 MPa or more, such as about 45 MPa or more, such as about 50 MPa or more, such as about 60 MPa or more, such as about 70 MPa or more, such as about 80 MPa or more, such as about 90 MPa or more, such as about 100 MPa or more, such as about 110 MPa or more, such as about 120 MPa or more, such as about 130 MPa or more, such as about 140 MPa or more, such as about 150 MPa or more, such as about 180 MPa or more, such as about 200 MPa or more. The flexural modulus may be determined in accordance with ISO 178:2019 at a temperature of about 23° C.

Relatedly, the copolyether-ester may have a particular Shore D hardness, which can provide an indication of the resistance to indentation of the copolyether-ester. In this regard, the Shore D hardness may be about 15 or more, such as about 20 or more, such as about 25 or more, such as about 30 or more, such as about 35 or more, such as about 40 or more, such as about 45 or more, such as about 50 or more. The Shore D hardness may be about 60 or less, such as about 55 or less, such as about 50 or less, such as about 45 or less, such as about 40 or less, such as about 35 or less, such as about 30 or less. Such hardness may allow for the copolyether-ester to provide the compliance necessary to effectively function for use in a particular application. The Shore D hardness may be determined in accordance with ISO 868-2003 (15 seconds).

In addition, the copolyether-ester may have other beneficial mechanical properties. For instance, the tensile stress at break may be about 45 MPa or less, such as about 40 MPa or less, such as about 35 MPa or less, such as about 30 MPa or less, such as about 30 MPa or less, such as about 25 MPa or less. The tensile stress at break may be about 5 MPa or more, such as about 10 MPa or more, such as about 15 MPa or more, such as about 20 MPa or more, such as about 25 MPa or more, such as about 30 MPa or more, such as about 35 MPa or more. The tensile stress at break may be determined in accordance with ISO 527-1/-2 (2012) at a temperature of about 23° C.

Also, the copolyether-ester may have a relatively high nominal strain at break. For instance, the nominal strain at break may be about 500% or more, such as about 550% or more, such as about 600% or more, such as about 650% or more, such as about 700% or more, such as about 750% or more, such as about 800% or more, such as about 850% or more. The nominal strain at break may be about 2000% or less, such as about 1800% or less, such as about 1600% or less, such as about 1400% or less, such as about 1200% or less, such as about 1100% or less, such as about 1000% or less, such as about 950% or less, such as about 900% or less, such as about 850% or less, such as about 800% or less. The nominal strain at break may be determined in accordance with ISO 527-1/-2 (2012) at a temperature of about 23° C.

Suitable copolyether-esters are also described in PCT/US19/49060 (published as WO/2020/047406), which is incorporated into this application by reference for its teaching of copolyether-esters. Specific copolyether-esters are commercially available from DuPont Specialty Products USA, LLC, of Wilmington, DE, under the Hytrel® trademark.

The composition may generally comprise about 10 wt. % or more, such as about 15 wt. % or more, such as about 20 wt. % or more, such as about 25 wt. % or more, such as about 30 wt. % or more, such as about 35 wt. % or more, such as about 40 wt. % or more of the copolyether-ester based on the weight of the composition. The composition may comprise about 60 wt. % or less, such as about 55 wt. % or less, such as about 50 wt. % or less, such as about 45 wt. % or less, such as about 40 wt. % or less, such as about 35 wt. % or less, such as about 30 wt. % or less, such as about 25 wt. % or less of the copolyether-ester based on the weight of the composition.

Ethylene Acrylic Copolymer

Suitable ethylene acrylic copolymers comprise (i) copolymerized units of a monomer having the structure represented by formula (C):

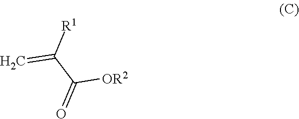

wherein R¹ is hydrogen or C₁-C₁₂ alkyl, and R² is C₁-C₁₂ alkyl, C₁-C₆) alkoxyalkyl, C₁-C₁₂ cyanoalkyl, or C₁-C₁₂ haloalkyl (e.g., fluoroalkyl or bromoalkyl), and wherein the polymerized units of the monomer are present in an amount ranging from about 40% to about 70% by weight of the ethylene acrylic copolymer; (ii) copolymerized units of an unsaturated carboxylic acid or an anhydride thereof, present in an amount of at least 2% by weight of the ethylene acrylic copolymer; and (iii) copolymerized units of ethylene, which can in some examples be present in an amount ranging from about 28% to about 58% by weight of the ethylene acrylic copolymer, or in other examples can constitute the remainder of the weight % of the ethylene acrylic copolymer.

The ethylene acrylic copolymer can be amorphous. The term “amorphous” refers to copolymers that exhibit little or no crystalline structure at room temperature in the unstressed state. Alternatively, an amorphous material has a heat of fusion of less than 4 J/g, as determined according to ASTM D3418-08. In one embodiment, the ethylene acrylic copolymer may be an elastomer.

The ethylene acrylic copolymer can comprise copolymerized units of a monomer of formula (C), such as an alkyl ester or alkoxyalkyl ester of propenoic acid, together with a cure site monomer and an ethylene monomer. Examples of suitable alkyl and alkoxyalkyl esters of propenoic acid include alkyl acrylates and alkoxyalkyl acrylates as well as monomers in which the propenoic acid is substituted with a C₁-C₁₂ alkyl group. Examples include alkyl methacrylates, alkyl ethacrylates, alkyl propacrylates, alkyl hexacrylates, alkoxyalkyl methacrylates, alkoxyalkyl ethacryates, alkoxyalkyl propacrylates, alkoxyalkyl hexacrylates, and any combination thereof.

The alkyl and alkoxyalkyl esters of propenoic acid and substituted propenoic acids can be C₁-C₁₂ alkyl esters of acrylic or methacrylic acid or C₁-C₂₀ alkoxyalkyl esters of acrylic or methacrylic acid. In one embodiment, the alkyl and alkoxyalkyl esters of propenoic acid include C₁-C₁₂ alkyl esters of acrylic or methacrylic acid, such as acrylic acid. Examples of alkyl and alkoxyalkyl esters of propenoic acid and substituted propenoic acid include methyl acrylate, methyl methacrylate, ethyl acrylate, ethyl methacrylate, butyl acrylate, butyl methacrylate, 2-ethylhexyl acrylate, 2-m ethoxyethylacrylate, 2-ethoxyethylacrylate, 2-(n-propoxy)ethylacrylate, 2-(n-butoxy)ethylacylate, 3-methoxypropylacrylate and 3-ethoxypropyl-acrylate. The ester group can comprise branched or unbranched C₁-C₈ alkyl groups, or unbranched C₁-C₄ alkyl groups. Specific examples include alkyl (meth)acrylate esters such as methyl acrylate, methyl methacrylate, ethyl acrylate, and butyl acrylate.

As indicated above, R¹ is hydrogen or C₁-C₁₂ alkyl. In this regard, in one embodiment, R¹ is hydrogen. In another embodiment, R¹ is a C₁-C₁₂ alkyl. For instance, the C₁-C₁₂ alkyl may be a C₁-C₁₀ alkyl, such as a C₁-C₈ alkyl, such as a C₁-C₆ alkyl, such as a C₁-C₄ alkyl, such as a C₁-C₃ alkyl, such as a C₁-C₂ alkyl, such as a C₁ alkyl. Accordingly, the alkyl may be methyl, ethyl, propyl, butyl, etc. In one embodiment, the alkyl may be methyl.

As indicated above, R² is C₁-C₁₂ alkyl, C₁-C₂₀ alkoxyalkyl, C₁-C₁₂ cyanoalkyl, or C₁-C₁₂ haloalkyl (e.g., fluoroalkyl or bromoalkyl). In this regard, in one embodiment, R² is a C₁-C₁₂ alkyl. For instance, the C₁-C₁₂ alkyl may be a C₁-C₁₀ alkyl, such as a C₁-C₈ alkyl, such as a C₁-C₆ alkyl, such as a C₁-C₄ alkyl, such as a C₁-C₃ alkyl, such as a C₁-C₂ alkyl, such as a C₁ alkyl. Accordingly, the alkyl may be methyl, ethyl, propyl, butyl, etc. In one embodiment, the alkyl may be methyl. In another embodiment, the alkyl may be butyl.

The polymerized units of the monomer of formula (C) can be present in an amount ranging from about 40% to about 70% by weight of the ethylene acrylic copolymer. For example, polymerized units of a propenoic acid ester comonomers can be present in an amount ranging from about 45% or from about 50% to about 70% by weight of the ethylene acrylic copolymer. In some examples, the concentration of polymerized units of propenoic acid ester comonomers can range from about 55% by to about 70% by weight of the ethylene acrylic copolymer. For example, the units may be present in an amount of about 40 wt. % or more, such as about 45 wt. % or more, such as about 50 wt. % or more, such as about 55 wt. % or more, such as about 60 wt. % or more based on the weight of the ethylene acrylic copolymer. The units may be present in an amount of about 70 wt. % or less, such as about 65 wt. % or less, such as about 60 wt. % or less, such as about 55 wt. % or less, such as about 50 wt. % or less based on the weight of the ethylene acrylic copolymer. If the concentration of propenoic acid ester is below about 40% by weight of the copolymer, the likelihood that some crystallinity will be present can be increased.

Furthermore, it should be understood that more than one monomer of formula (C) may be utilized in forming the ethylene acrylic copolymer. For instance, two monomers of formula (C) or three monomers of formula (C) may be utilized in forming the ethylene acrylic copolymer.

The ethylene acrylic copolymer further comprises a copolymerized cure site monomer such as a carboxylic acids or an anhydride thereof, or any mixture of the acid and anhydride of the acid. Suitable unsaturated carboxylic acids include acrylic acid and methacrylic acid, 1,4-butenedioic acids, citraconic acid, and monoalkyl esters of 1,4-butenedioic acids. The 1,4-butenedioic acids may exist in cis- or trans-form or both, i.e. maleic acid or fumaric acid, prior to polymerization. Suitable cure site comonomers also include anhydrides of unsaturated carboxylic acids, for example, maleic anhydride, citraconic anhydride, and itaconic anhydride. Cure site monomers can include maleic acid and any of its half acid esters (monoesters) or diesters, such as the methyl or ethyl half acid esters (e.g., monoethyl maleate); fumaric acid and any of its half acid esters or diesters, such as the methyl, ethyl or butyl half acid esters; and monoalkyl and monoarylalkyl esters of itaconic acid. The cure site monomer can be present in some examples in an amount ranging from about 2% to about 5% by weight of the ethylene acrylic copolymer, e.g., 2% to 4%. For example, the cure site monomer may be present in an amount of about 2 wt. % or more, such as about 2.5 wt. % or more, such as about 3 wt. % or more, such as about 3.5 wt. % or more, such as about 4 wt. % or more based on the weight of the ethylene acrylic copolymer. The cure site monomer may be present in an amount of about 5 wt. % or less, such as about 4.5 wt. % or less, such as about 4 wt. % or less, such as about 3.5 wt. % or less, such as about 3 wt. % or less based on the weight of the ethylene acrylic copolymer.

In addition to comprising the polymerized units of a monomer of formula (C) and the cure site comonomer(s), the ethylene acrylic copolymer comprises copolymerized units of ethylene. The copolymerized units of ethylene can constitute the remainder of the weight % of the ethylene acrylic copolymer, after accounting for the copolymerized units of the monomer of formula (C) and the copolymerized units of the unsaturated carboxylic acid or an anhydride thereof. For example, the copolymerized units of ethylene can be present in an amount ranging from about 28% to about 58% by weight of the ethylene acrylic copolymer, the balance of the weight percent being attributed to the copolymerized units of the monomer of formula (C) and the copolymerized units of the unsaturated carboxylic acid or an anhydride thereof. For example, the units of ethylene may be present in an amount of about 28 wt. % or more, such as about 30 wt. % or more, such as about 35 wt. % or more, such as about 40 wt. % or more, such as about 45 wt. % or more, such as about 50 wt. % or more based on the weight of the ethylene acrylic copolymer. The units of ethylene may be present in an amount of about 58 wt. % or less, such as about 55 wt. % or less, such as about 40 wt. % or less, such as about 45 wt. % or less, such as about 30 wt. % or less, such as about 35 wt. % or less based on the weight of the ethylene acrylic copolymer.

The ethylene acrylic copolymer can consist essentially of or consist of the copolymerized units of the monomer of formula (C), copolymerized units of an unsaturated carboxylic acid or an anhydride thereof, and copolymerized units of ethylene. “Consist essentially of” in this context refers an ethylene acrylic copolymer that does not materially diminish the elastomeric properties of the ethylene acrylic copolymer if the copolymer consisted solely of the three copolymerized units.

Specific examples of the ethylene acrylic copolymer include copolymers of (i) methyl acrylate, butyl acrylate, or any combination thereof, present in an amount ranging from about 50% to about 70% by weight of the ethylene acrylic copolymer or in amounts as mentioned above; (ii) a cure site monomer having carboxylic acid functionality, present in an amount ranging from about 2% to about 5% by weight of the ethylene acrylic copolymer (e.g., 2% to 4%) or in amounts as mentioned above; and (iii) ethylene, which constitutes the remainder of the weight % of the ethylene acrylic copolymer or in amounts as mentioned above. Suitable ethylene acrylic copolymers are also commercially available from DuPont Specialty Products USA, LLC, of Wilmington, DE, under the Vamac® trademark.

The ethylene acrylic copolymer may have a relatively low glass transition temperature. For example, the glass transition temperature may be about −45° C. or more, such as about −40° C. or more, such as about −35° C. or more, such as about −30° C. or more, such as about −25° C. or more. The glass transition temperature may be about −20° C. or less, such as about −25° C. or less, such as about −30° C. or less, such as about −35° C. or less, such as about −40° C. or less. The glass transition temperature may be determined using means generally known in the art, such as differential scanning calorimetry.

In addition, the ethylene acrylic copolymer may have a 100% modulus, as determined in accordance with ASTM D412-16(2021), of from about 2 MPa to about 10 MPa. For example, the 100% modulus may be about 2 MPa or more, such as about 3 MPa or more, such as about 4 MPa or more, such as about 5 MPa or more, such as about 6 MPa or more, such as about 7 MPa or more, such as about 8 MPa or more, such as about 9 MPa or more. The 100% modulus may be about 10 MPa or less, such as about 9 MPa or less, such as about 8 MPa or less, such as about 7 MPa or less, such as about 6 MPa or less, such as about 5 MPa or less, such as about 4 MPa or less, such as about 3 MPa or less.

The ethylene acrylic copolymer may have a tensile strength, as determined in accordance with ASTM D412-16(2021), of from about 2 MPa to about 25 MPa. For example, the tensile strength may be about 2 MPa or more, such as about 3 MPa or more, such as about 4 MPa or more, such as about 5 MPa or more, such as about 6 MPa or more, such as about 7 MPa or more, such as about 9 MPa or more, such as about 11 MPa or more, such as about 13 MPa or more, such as about 15 MPa or more, such as about 17 MPa or more, such as about 19 MPa or more, such as about 21 MPa or more. The tensile strength may be about 25 MPa or less, such as about 22 MPa or less, such as about 20 MPa or less, such as about 18 MPa or less, such as about 16 MPa or less, such as about 14 MPa or less, such as about 12 MPa or less, such as about 10 MPa or less, such as about 8 MPa or less, such as about 6 MPa or less, such as about 5 MPa or less, such as about 4 MPa or less, such as about 3 MPa or less. The ethylene acrylic copolymer may have an elongation, as determined in accordance with ASTM D412-16(2021), of from about 100% to about 600%. The elongation may be about 100% or more, such as about 200% or more, such as about 300% or more, such as about 400% or more, such as about 600% or more. The elongation may be about 600% or less, such as about 500% or less, such as about 400% or less, such as about 300% or less, such as about 200% or less.

The ethylene acrylic copolymer may have a Shore A hardness, as determined in accordance with ASTM D2240-15(2021), of from about 40 to about 90. For example, the Shore A hardness may be about 40 or more, such as about 50 or more, such as about 60 or more, such as about 70 or more, such as about 80 or more. The Shore A hardness may be about 90 or less, such as about 80 or less, such as about 70 or less, such as about 60 or less, such as about 50 or less.

The ethylene acrylic copolymer may be in the thermoplastic composition in an amount of from about 0.5% to about 15% by weight, such as about 0.5% to about 12% by weight, of the thermoplastic composition. For example, the ethylene acrylic copolymer may be present in an amount of about 0.5 wt. % or more, such as about 1 wt. % or more, such as about 2 wt. % or more, such as about 3 wt. % or more, such as about 4 wt. % or more, such as about 5 wt. % or more, such as about 6 wt. % or more, such as about 7 wt. % or more, such as about 8 wt. % or more, such as about 9 wt. % or more, such as about 10 wt. % or more, such as about 11 wt. % or more based on the weight of the thermoplastic composition. The ethylene acrylic copolymer may be present in an amount of about 15 wt. % or less, such as about 14 wt. % or less, such as about 13 wt. % or less, such as about 12 wt. % or less, such as about 11 wt. % or less, such as about 10 wt. % or less, such as about 9 wt. % or less, such as about 8 wt. % or less, such as about 6 wt. % or less, such as about 5 wt. % or less based on the weight of the thermoplastic composition.

Further, the weight ratio of the copolyether-ester to the ethylene acrylic copolymer in the thermoplastic composition ranges from 98:2 to 65:35. For example, the weight ratio may be 65:35 or more, such as 70:30 or more, such as 75:25 or more, such as 80:20 or more, such as 85:15 or more, such as 90:10 or more, such as 92:8 or more, such as 94:6 or more, such as 95:5 or more. The weight ratio may be 98:2 or less, such as 97:3 or less, such as 96:4 or less, such as 95:5 or less, such as 94:6 or less, such as 92:8 or less, such as 90:10 or less, such as 85:15 or less, such as 80:20 or less, such as 75:25 or less.

Other Additives

The thermoplastic composition further comprises a flame retardant such as aluminum trihydrate (ATH). The ATH can for example be the one sold under the tradename Hydral® by the Huber Corporation.

In some examples the ATH is present in an amount of at least 40%, e.g., 40% to 70%, by weight of the thermoplastic composition. In a further example, the ATH is present in an amount of at least 50%, e.g., 50% to 70%, by weight of the thermoplastic composition. In a still further example, the ATH is present in an amount of about 60% by weight of the thermoplastic composition. For example, the ATH may be present in an amount of about 40 wt. % or more, such as about 45 wt. % or more, such as about 50 wt. % or more, such as about 55 wt. % or more, such as about 60 wt. % or more, such as about 65 wt. % or more based on the weight of the thermoplastic composition. The ATH may be present in an amount of about 70 wt. % or less, such as about 65 wt. % or less, such as about 60 wt. % or less, such as about 55 wt. % or less, such as about 50 wt. % or less, such as about 45 wt. % or less based on the weight of the thermoplastic composition.

In some examples, the thermoplastic composition is free of magnesium hydroxide (MDH). It was found that ATH in some examples provides far superior performance relative to MDH. In this regard, the thermoplastic composition may comprise less than about 0.2 wt. %, such as less than about 0.15 wt. %, such as less than about 0.1 wt. %, such as less than about 0.05 wt. %, such as less than about 0.01 wt. %, such as about 0 wt. % of MDH based on the weight of the thermoplastic composition. In other examples, the thermoplastic composition is free of any liquid crystalline polymer. Liquid crystalline polymers have a high Tₘ which in some instances can preclude the use of ATH as a flame retardant because ATH can decompose above about 180° C. In this regard, the thermoplastic composition may comprise less than about 0.2 wt. %, such as less than about 0.15 wt. %, such as less than about 0.1 wt. %, such as less than about 0.05 wt. %, such as less than about 0.01 wt. %, such as about 0 wt. % of liquid crystalline polymer based on the weight of the thermoplastic composition.

The thermoplastic composition can also comprise a silicone additive. The silicone additive may be a polymeric silicone additive, such as a polydialkylsiloxane such as a polydimethylsiloxane. A variety of silicone additives can be used such as an optionally functionalized polydimethylsiloxane, e.g., a vinyl functionalized polydimethylsiloxane such as the one sold under the tradename Xiameter®, or a non-functionalized polydimethylsiloxane such as the one sold under the tradename Dowsil®. In one embodiment, the silicone additive may be a functionalized polydialkylsiloxane such as a functionalized polydimethylsiloxane.

The silicone additive can be present in an amount ranging from about 0.1% to about 4% by weight of the thermoplastic composition, e.g., 1% to 4% or 1% to 2%. For example, the antioxidant can be present in an amount of about 0.1 wt. % or more, such as about 0.2 wt. % or more, such as about 0.3 wt. % or more, such as about 0.5 wt. % or more, such as about 1 wt. % or more, such as about 1.2 wt. % or more, such as about 1.5 wt. % or more, such as about 1.7 wt. % or more, such as about 2 wt. % or more, such as about 2.5 wt. % or more, such as about 3 wt. % or more based on the weight of the thermoplastic composition. The antioxidant may be present in an amount of about 4 wt. % or less, such as about 3.5 wt. % or less, such as about 3 wt. % or less, such as about 2.5 wt. % or less, such as about 2 wt. % or less, such as about 1.8 wt. % or less, such as about 1.5 wt. % or less, such as about 1.3 wt. % or less, such as about 1 wt. % or less based on the weight of the thermoplastic composition.

In some examples, the thermoplastic composition can also comprise an antioxidant. The antioxidant may be a phenolic antioxidant, a phosphite antioxidant, an amine antioxidant or a mixture thereof. In one embodiment, the antioxidant may be an amine antioxidant, such as an arylamine antioxidant. Suitable antioxidants include arylamine antioxidants such as 4,4′-bis(alpha, alpha-dimethylbenzyl)diphenylamine (e.g., Naugard®, available from Addivant Corporation), benzenamine, N-phenyl-, reaction products with 2,4,4-trimethylpentene, etc. In one embodiment, the arylamine antioxidant is 4,4′-bis(alpha, alpha-dimethylbenzyl)diphenylamine.

The antioxidant can be present in any amount and type needed to achieve the technical goals of the composition, typically ranging from about 0.1% to about 1% by weight of the thermoplastic composition. For example, the antioxidant can be present in an amount of about 0.1 wt. % or more, such as about 0.2 wt. % or more, such as about 0.3 wt. % or more, such as about 0.4 wt. % or more, such as about 0.5 wt. % or more, such as about 0.6 wt. % or more based on the weight of the thermoplastic composition. The antioxidant may be present in an amount of about 1 wt. % or less, such as about 0.9 wt. % or less, such as about 0.8 wt. % or less, such as about 0.7 wt. % or less, such as about 0.6 wt. % or less, such as about 0.5 wt. % or less, such as about 0.4 wt. % or less based on the weight of the thermoplastic composition.

In addition to the above, the composition may optionally include other additives as generally known in the art. These may include, but are not limited to, compatibilizers, pigments, colorants, dyes, dispersants, other flame retardants, other antioxidants, conductive particles, UV-inhibitors, UV-stabilizers, adhesion promoters, fatty acids, esters, paraffin waxes, neutralizers, metal deactivators, tackifiers, calcium stearate, dessicants, stabilizers, light stabilizers, light absorbers, coupling agents, plasticizers, lubricants, blocking agents, anti-blocking agents, antistatic agents, waxes, nucleating agents, slip agents, other acid scavengers, lubricants, adjuvants, polymeric additives, preservatives, thickeners, rheology modifiers, humectants, reinforcing and non-reinforcing fillers, and combinations thereof.

Such other additives may be provided in an amount as necessary. For instance, the additive, individually or in combination, may be provided in an amount of about 0.1 wt. % or more, such as about 0.2 wt. % or more, such as about 0.3 wt. % or more, such as about 0.4 wt. % or more, such as about 0.5 wt. % or more, such as about 0.6 wt. % or more, such as about 0.7 wt. % or more, such as about 0.8 wt. % or more, such as about 0.9 wt. % or more, such as about 1 wt. % or more, such as about 1.5 wt. % or more, such as about 2 wt. % or more, such as about 2.5 wt. % or more, such as about 3 wt. % or more, such as about 3.5 wt. % or more, such as about 4 wt. % or more, such as about 5 wt. % or more, such as about 8 wt. % or more, such as about 10 wt. % or more, such as about 15 wt. % or more, such as about 20 wt. % or more, such as about 25 wt. % or more based on the weight of the thermoplastic composition. The additive, individually or in combination, may be provided in an amount of about 40 wt. % or less, such as about 35 wt. % or less, such as about 30 wt. % or less, such as about 25 wt. % or less, such as about 20 wt. % or less, such as about 18 wt. % or less, such as about 15 wt. % or less, such as about 13 wt. % or less, such as about 10 wt. % or less, such as about 8 wt. % or less, such as about 6 wt. % or less, such as about 5 wt. % or less, such as about 4 wt. % or less, such as about 3 wt. % or less, such as about 2.5 wt. % or less, such as about 2 wt. % or less, such as about 1.5 wt. % or less, such as about 1.3 wt. % or less, such as about 1 wt. % or less, such as about 0.8 wt. % or less, such as about 0.7 wt. % or less, such as about 0.6 wt. % or less, such as about 0.5 wt. % or less, such as about 0.4 wt. % or less, such as about 0.3 wt. % or less, such as about 0.2 wt. % or less based on the weight of the thermoplastic composition.

Specific Embodiments

Specific non-limiting examples of the thermoplastic composition are those comprising (a) a copolyether-ester prepared from (i) a monomer comprising poly(tetramethylene oxide) glycol, (ii) a mixture of terephthalic acid and isophthalic acid, and (iii) 1,4-butanediol, or wherein the copolyether-ester is prepared from (i) a monomer comprising poly(tetramethylene oxide) glycol; (ii) terephthalic acid, and (iii) 1,4-butanediol; (b) an ethylene acrylic copolymer comprising copolymerized units of (i) methyl acrylate, butyl acrylate, or any combination thereof, (ii) an unsaturated carboxylic acid or an anhydride thereof, and (iii) ethylene; and (c) at least 40% by weight of aluminum trihydrate; the weight ratio of the copolyether-ester to the ethylene acrylic copolymer in the thermoplastic composition ranges from 98:2 to 65:35. The amounts of (a), (b), and (c) in the thermoplastic composition, as well as the amounts of the comonomers of the ethylene acrylic copolymer can be any of those described in this application in any suitable combination. Such compositions can also comprise a silicone additive, antioxidant, or both, including any of those described in this application.

Composition Formation

The composition described herein can be processed using techniques generally known in the art. For instance, the components (copolyether-ester, ethylene acrylic copolymer, ATH, and other optional additives) may be melt-mixed (also referred to as melt-blended). Utilizing such an approach, the components may be well-dispersed throughout the composition. Furthermore, the components may be provided in a single-step addition or in a step-wise manner. The processing may be conducted in a chamber, which may be any vessel that is suitable for blending the composition under the necessary temperature and shearing force conditions. In this respect, the chamber may be a mixer, such as a Banbury™ mixer or a Brabender™ mixer, an extruder, such as a co-rotating extruder, a counter-rotating extruder, or a twin-screw extruder, a co-kneader, such as a Buss® kneader, etc. The melt blending may be carried out at a temperature ranging from 150 to 300° C., such as from 200 to 280° C., such as from 220 to 270° C. or 240 to 260° C. However, such processing should be conducted for each respective composition at a desired temperature to minimize any degradation. Upon completion of the mixing/blending, the composition may be milled, chopped, extruded, pelletized, or processed by any other desirable technique. In certain instances, the components may be melt-blended and directly fed to a downstream operation or molding apparatus for formation of a resulting molded part or article.

Molded Parts and Applications

The composition is suitable for forming molded parts and articles. In this regard, the composition may be molded into a molded part/article using conventional molding apparatuses and techniques, such as injection molding, extrusion molding, compression molding, blow molding, rotational molding, overmolding, thermoforming, etc. In general, these processes may include heating the composition to a temperature that is equal to or in excess of the melt temperature to form a pre-form for a mold cavity to then form the molded part, cooling the molded part to a temperature at or below the crystallization temperature, and releasing the molded part/article from a mold. The mold cavity defines the shape of the molded part/article. The molded part/article is cooled within the mold at a temperature at or below the crystallization temperature and the molded part/article can subsequently be released from the mold. The process may also utilize extrusion molding. In this regard, the composition may be extruded as described herein. Upon exiting the extruder, the composition may be formed or shaped to a desired part/article. Such part/article may be formed by using a particular die to shape the composition as it exits the extruder. Such shaping/forming process, such as the extrusion process, may be an automated or robotic process.

The composition as disclosed herein may be utilized in a variety of applications. For instance, the composition may be suitable for an automotive part, an electronic part, a consumer goods article, a medical article, among others.

One non-limiting example of an application of the thermoplastic composition is a wire or cable jacket prepared from the composition. Generally, a wire or cable includes an elongated protective member that defines a passageway for receiving one or more items, such as a conductor, fluid, etc. The elongated protective member may contain multiple layers or a single layer. The wire or cable may be a metal wire (e.g., copper wire), a telephone line, an optical fiber, a telecommunication cable, etc. In some examples, the wire or cable jacket can be an optical fiber cable jacket. In this regard, the present disclosure may also be directed to a wire or cable, such as an optical fiber cable, comprising a jacket formed from the thermoplastic composition as defined herein.

### EXAMPLES

The following examples further illustrate this disclosure. The scope of the disclosure and claims is not limited by the scope of the following examples.

### Materials

Copolyester-ether

CP-1 comprises copolymerized residues of 1000 g/mol polytetramethylene ether glycol (“PTMEG”) (55.1 wt %), terephthalic acid (27.5 wt %), isophthalic acid (8 wt %). and 1,4-butanediol (19.6 wt %). The polymer has a melting peak temperature of 150° C. as measured according to ASTM D3418-08.

CP-2 comprises copolymerized residues of 2000 g/mol PTMEG (72.5 wt %), terephthalic acid (18.4 wt %), and 1,4-butanediol (9.1 wt %). The polymer has a melting peak temperature of 170° C. as measured according to ASTM D3418-08.

Ethylene Acrylic Elastomer

EA-1 comprises 55 wt % of copolymerized units derived from methyl acrylate, 4 wt % of copolymerized units of a cure site comonomer having carboxylic acid functionality, and the remainder copolymerized units of ethylene.

EA-2 comprises 55 wt % of copolymerized units derived from methyl acrylate, 2 wt % of copolymerized units of a cure site comonomer having carboxylic acid functionality, and the remainder copolymerized units of ethylene.

EA-3 comprises 23 wt % of copolymerized units derived from methyl acrylate, 41 wt % of copolymerized units derived from butyl acrylate, 3.2 wt % of copolymerized units of cure site comonomer having carboxylic acid functionality, and the remainder copolymerized units of ethylene.

EA-4 comprises 62 wt % of copolymerized units derived from methyl acrylate, and the remainder copolymerized units of ethylene. Copolymerized units of cure site comonomer having carboxylic acid functionality are absent.

Acrylic Elastomer

A-1 comprises 50 wt % copolymerized units of butyl acrylate, 48 wt % copolymerized units of ethylacrylate, and 2 wt % of copolymerized units of a cure site monomer having carboxylic acid functionality.

Silicone

S-1 is a vinyl functionalized polydimethylsiloxane available from Dow Inc. as Xiameter® RBG-0900.

S-2 is a non-functional polydimethylsiloxane available from Dow Inc. as Dowsil® 4-7034

Other Ingredients

Aluminum trihydrate (ATH) is available from the Huber Corporation as Hydral® Coat 8.

Magnesium dihydroxide (MDH) is available from Kisuma Chemicals B.V as Kisuma® 5A.

Anti-oxidant (AO) is available from Addivant Corporation as Naugard® 445

### Test Methods

Melt Index (“MI”): Measured per ASTM D1238-20 (procedure A), using conditions of 170° C./21 Kg weight. Samples were dried in a vacuum oven at 60° C. for 4 hours prior to testing.

Tensile properties: Measured per ASTM D420-6, die C, using specimens stamped from the machine direction of extruded tapes 0.8 mm thick. Tapes were produced using a 19.1 mm diameter single screw extruder fitted with a 63.4 mm×1.5 mm slot die. Extruder temperatures were set to 160° C. (feed zone), 170° C., and 180° C. (discharge), with a die temperature of 180° C. Tensile specimens stamped from the extruded tape were conditioned for 24 hrs at 50% RH prior to testing. Data reported are the median of three specimens.

Limiting Oxygen Index (“1_01”): Measured per ASTM D2863-19 procedure A using type I specimens cut from compression molded plaques.

### Example 1

Compounds were mixed in a Haake™ Rheomix lab mixing bowl fitted with cam rotors. The bowl set temperature was 160° C., and compounds were mixed at 50 rpm rotor speed for 3 minutes. Discharge temperatures ranged from 170° C. to 180° C. depending on the composition. After discharge, the batch was cooled, granulated, and further processed as described above to produce specimens for MI, tensile testing to measure tensile strength (“TS”) and elongation at break (“EB”), and LOI.

Comparative examples C1 and C2 provide relatively low LOI, in the range of 31% to 35%, whereas inventive examples E1-E4 achieve LOI in the range of 39% to 47%. LOI increases with increasing content of EA-1, but even E2 and E3, with EA to CP ratios of 5:95 and 2.5:97.5 respectively, increase LOI by four to six percentage points compared to C1. EB also increases with increasing EA-1 content, such that E1 and E4 exhibit dramatically improved EB compared to C1 and C2, respectively. All inventive examples in Table 1 exhibit good extrusion processability, having MI of 1.0 g/10 minutes or greater.

TABLE 1

| | C1 | C2 | E1 | E2 | E3 | E4 |
|---|---|---|---|---|---|---|
| | wt % | wt % | wt % | wt % | wt % | wt % |
| CP-1 | 39.5 | | 27.65 | 37.525 | 38.513 | 27.65 |
| CP-2 | | 39.5 | | | | |
| EA-1 | | | 11.85 | 1.975 | 0.987 | |
| EA-2 | | | | | | 11.85 |
| ATH | 60 | 60 | 60 | 60 | 60 | 60 |
| AO | 0.5 | 0.5 | 0.5 | 0.5 | 0.5 | 0.5 |
| Melt index (g/ | 2.2 | 1.0 | 1.8 | 2.4 | 2.5 | 1.7 |
| 10 min) | | | | | | |
| Tensile Strength | 16.0 | 11.9 | 10.0 | 14.8 | 15.6 | 9.8 |
| (MPa) | | | | | | |
| Elongation at break | 70 | 80 | 155 | 60 | 60 | 230 |
| (%) | | | | | | |
| Limiting Oxygen | 35 | 31 | 47 | 39 | 41 | 47 |
| Index | | | | | | |

### Example 2

Compounds in Table 2A-2B were prepared as described in Example 1, and illustrate the influence of silicone content and type, the importance of the ethylene acrylate (“EA”) carboxylic acid cure site, the use of magnesium hydroxide (“MDH” or Mg(OH)₂) in place of aluminum trihydrate (“ATH”), and the use of acrylic elastomer in place of ethylene acrylic elastomer.

C1 (from Table 1), C3, and C4 show that increasing content of silicone S-1 increases LOI at the expense of decreasing EB. In contrast, inventive examples E1 (from Table 1), E5-7 and E10-11 show that addition of S-1 up to 1.5% in the compound increases LOI with no adverse effect on EB. At very high S-1 levels of 3.5% (see E8),

EB decreases but remains far greater than control compounds lacking EA, while providing exceptionally high LOI of 55%.

C5 demonstrates the importance of the copolymerized carboxylic acid cure site as a component of the ethylene acrylic elastomer. EA-4 lacks this cure site and provides far less LOI improvement than inventive examples E7 and E10 that are based on ethylene acrylic elastomers with the cure site.

C6 demonstrates the effect of replacing ATH with MDH. C6 has very low flowability (MI), and inferior EB and LOI compared to otherwise equivalent ATH compounds E7 and E10.

C7 substitutes an acrylic elastomer for the ethylene acrylic elastomer in E7 and E10. C₇ exhibits poor extrusion processability and no flow in the melt index test.

E9 demonstrates that the vinyl functionalized silicone S-1 can provide improved performance relative to the non-functional silicone S-2 for improvement of LOI (compare E9 with E7), and can also improve TS and EB.

TABLE 2A

| | C3 | C4 | C5 | C6 | C7 |
|---|---|---|---|---|---|
| | wt % | wt % | wt % | wt % | wt % |
| CP-1 | 38 | 36 | 26.6 | 26.6 | 26.6 |
| EA-1 | | | | 11.4 | |
| EA-4 | | | 11.4 | | |
| A-1 | | | | | 11.4 |
| S-1 | 1.5 | 3.5 | 1.5 | 1.5 | 1.5 |
| S-2 | | | | | |
| ATH | 60 | 60 | 60 | | 60 |
| MDH | | | | 60 | 0.5 |
| AO | 0.5 | 0.5 | 0.5 | 0.5 | |
| Melt index (g/10 min) | 2.2 | 2.2 | 2.1 | 0.2 | no flow |
| Tensile Strength (MPa) | 13.3 | 14.5 | 9.6 | 18.0 | 8.5 |
| Elongation at break (%) | 42 | 54 | 145 | 65 | 210 |
| Limiting Oxygen Index | 38 | 47 | 41 | 34 | nm |

nm = not measured

TABLE 2B

| | E5 | E6 | E7 | E8 | E9 | E10 | E11 |
|---|---|---|---|---|---|---|---|
| | wt % | wt % | wt % | wt % | wt % | wt % | wt % |
| CP-1 | 27.3 | 26.95 | 26.6 | 25.2 | 26.6 | 26.6 | |
| CP-2 | | | | | | | 26.6 |
| EA-1 | 11.7 | 11.55 | 11.4 | 10.8 | 11.4 | | |
| EA-3 | | | | | | 11.4 | 11.4 |
| S-1 | 0.5 | 1 | 1.5 | 3.5 | | 1.5 | 1.5 |
| S-2 | | | | | 1.5 | | |
| ATH | 60 | 60 | 60 | 60 | 60 | 60 | 60 |
| MDH | | | | | | | |
| AO | 0.5 | 0.5 | 0.5 | 0.5 | 0.5 | 0.5 | 0.5 |
| Melt index (g/ | 2.2 | 2.4 | 2.8 | 2.4 | 2.2 | 2 | 1.4 |
| 10 min) | | | | | | | |
| Tensile Strength | 9.9 | 9.8 | 9.5 | 10.2 | 11.1 | 8.4 | 10.8 |
| (MPa) | | | | | | | |
| Elongation at break | 190 | 220 | 180 | 120 | 200 | 155 | 180 |
| (%) | | | | | | | |
| Limiting Oxygen | 48 | 51 | 49 | 55 | 43 | 48 | 42 |
| Index | | | | | | | |

Features and advantages of this disclosure are apparent from the detailed specification, and the claims cover all such features and advantages. Numerous variations will occur to those skilled in the art, and any variations equivalent to those described in this disclosure fall within the scope of this disclosure. Those skilled in the art will appreciate that the conception upon which this disclosure is based may be used as a basis for designing other compositions and methods for carrying out the several purposes of this disclosure. As a result, the claims should not be considered as limited by the description or examples.

1-31. (canceled)

32. A thermoplastic composition comprising:
a) a copolyether-ester;
b) an ethylene acrylic copolymer comprising:
i) copolymerized units of a monomer having the structure: 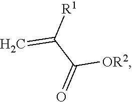
wherein R¹ is hydrogen C₁-C₁₂ alkyl, and R² is C₁-C₁₂ alkyl, C₁-C₂₀ alkoxyalkyl, C₁-C₁₂ cyanoalkyl, or C₁-C₁₂ haloalkyl, and wherein the polymerized units of the monomer are present in an amount ranging from about 40% to about 70% by weight of the ethylene acrylic copolymer;
ii) copolymerized units of an unsaturated carboxylic acid or an anhydride thereof, present in an amount of at least 2% by weight of the ethylene acrylic copolymer; and
iii) copolymerized units of ethylene; and
c) aluminum trihydrate (ATH), present in an amount of at least 40% by weight of the thermoplastic composition;
wherein the weight ratio of the copolyether-ester to the ethylene acrylic copolymer in the thermoplastic composition ranges from 98:2 to 65:35.

33. The thermoplastic composition of claim 32, which exhibits a melt flow index of at least 1 g/10 min, measured according to ASTM D1238-20 (procedure A), conducted at 170° C. using a 21 kg weight.

34. The thermoplastic composition of claim 32, which exhibits a tensile strength ranging from about 8 MPa to about 16 MPa, measured according to ASTM D420-6, die C, from a sample stamped from the machine direction of extruded tapes having a thickness of about 0.8 mm.

35. The thermoplastic composition of claim 32, which exhibits an elongation at break ranging from about 60% to about 230%.

36. The thermoplastic composition of claim 32, which exhibits a limiting oxygen index ranging from about 35% to about 60%, measured according to ASTM D2863-19, procedure A, using a type I specimen cut from a compression molded plaque.

37. The thermoplastic composition of claim 32, wherein the copolyether-ester is prepared from (i) a monomer comprising poly(tetramethylene oxide) glycol, poly(trimethylene oxide) glycol, polypropylene oxide glycol, or any mixture thereof; (ii) a dicarboxylic acid selected from isophthalic acid, terephthalic acid, or any mixture thereof; and (iii) a diol selected from 1,4-butanediol, 1,3-propanediol, or any mixture thereof.

38. The thermoplastic composition of claim 32, wherein the copolyether-ester is prepared from (i) a monomer comprising poly(tetramethylene oxide) glycol; (ii) isophthalic acid, terephthalic acid, or any mixture thereof; and (iii) a diol selected from 1,4-butanediol, 1,3-propanediol, or any mixture thereof.

39. The thermoplastic composition of claim 32, wherein the copolyether-ester is prepared from (i) a monomer comprising poly(tetramethylene oxide) glycol; (ii) a mixture of terephthalic acid and isophthalic acid, and (iii) 1,4-butanediol; or wherein the copolyether-ester is prepared from (i) a monomer comprising poly(tetramethylene oxide) glycol; (ii) terephthalic acid, and (iii) 1,4-butanediol.

40. The thermoplastic composition of claim 32, wherein the copolyether-ester is present in an amount ranging from about 20% to about 50% by weight of the thermoplastic composition.

41. The thermoplastic composition of claim 32, wherein the copolyether-ester has a peak melting temperature of about 210° C. or less, as measured according to ASTM D3418-08.

42. The thermoplastic composition of claim 32, wherein copolymerized units of the unsaturated carboxylic acid or the anhydride thereof are present in an amount ranging from about 2% to about 4% by weight of the ethylene acrylic copolymer.

43. The thermoplastic composition of claim 32, wherein the copolymerized units of ethylene are present in an amount ranging from about 28% to about 58% by weight of the ethylene acrylic copolymer.

44. The thermoplastic composition of claim 32, wherein the monomer (i) is methyl acrylate, butyl acrylate, or any combination thereof.

45. The thermoplastic composition of claim 32, comprising about 25% to about 40% of the copolyether-ester by weight of the thermoplastic composition and about 0.5% to about 12% of the ethylene acrylic copolymer by weight of the thermoplastic composition.

46. The thermoplastic composition of claim 32, comprising from about 40% to about 70% aluminum trihydrate by weight of the thermoplastic composition.

47. The thermoplastic composition of claim 32, which is free of magnesium hydroxide (MDH).

48. The thermoplastic composition of claim 32, further comprising a polydimethylsiloxane additive in an amount ranging from about 0.1° A to about 4% by weight of the thermoplastic composition.

49. The thermoplastic composition of claim 48, wherein the polydimethylsiloxane additive is a functionalized polydimethylsiloxane.

50. A wire or cable jacket prepared from the thermoplastic composition of claim 32.

51. An optical fiber comprising the wire or cable jacket of claim 50.
